(19) United States
(12) Patent Application Publication
(10) Pub. No.: US 2025/0141088 A1
(43) Pub. Date: May 1, 2025

(54) ANTENNA SECTIONS

(71) Applicant: Hewlett-Packard Development Company, L.P., Spring, TX (US)

(72) Inventors: Chin-Hung MA, Taipei City (TW); Chih-Hung CHIEN, Taipei City (TW); Pai-Cheng HUANG, Taipei City (TW)

(73) Assignee: Hewlett-Packard Development Company, L.P., Spring, TX (US)

(21) Appl. No.: 18/835,969

(22) PCT Filed: Feb. 25, 2022
(86) PCT No.: PCT/US2022/017830

§ 371 Date: Aug. 5, 2024

(51) Int. Cl. H01Q 1/22

(52) U.S. Cl. CPC H01Q 1/2258

(57) ABSTRACT

In some examples, an electronic device includes a lid section, abase section coupled to the lid section via a hinge section, the base section and the lid section having substantially parallel edges when in a closed position, and an antenna section including a first surface coupled to the lid section and a second surface coupled to the first surface via a pivot and to the base section. In response to a rotation of the hinge section, the pivot is to rotate between a first orientation when the base section and the lid section are in the closed position and a second orientation when the base section and the lid section are in an opened position.

### BACKGROUND

Electronic devices such as notebooks, laptops, desktops, tablets, and smartphones include antennas to enable wireless communication. A number of antennas utilized to enable wireless communications varies responsive to differences in wireless communication technology.

### BRIEF DESCRIPTION OF THE DRAWINGS

Various examples are described below referring to the following figures.

FIG. 1 is a block diagram of an electronic device having an antenna section, in accordance with various examples.

FIGS. 2A and 2B are block diagrams of an electronic device having an antenna section, in accordance with various examples.

FIGS. 3A and 3B are block diagrams of an electronic device having an antenna section, in accordance with various examples.

FIG. 4 is a block diagram of an electronic device having an antenna section, in accordance with various examples.

FIG. 5 is a block diagram of an electronic device having an antenna section, in accordance with various examples.

### DETAILED DESCRIPTION

As described above, electronic devices include antennas to enable wireless communications. To enhance antenna performance, the antennas are often located within a frame of an electronic device, co-located with a hinge of the electronic device, or a combination thereof. To locate the antennas within the frame, the frame is formed from a composite of metal and di-electric material. A molding process utilized to form the composite increases a manufacture time and cost.

As wireless communication technology advances, the number of antennas utilized to enable wireless communications across specified bandwidths increases and antenna configurations evolve to transceive electromagnetic (EM) waves of the specified bandwidths. The increase in the number of antennas, the adjustment of the configuration of the antenna or the multiple antennas, or a combination thereof, increases interference with other electronic components (e.g., input/output (I/O) ports, sensors, I/O components, a control panel, a display panel) within the frame of the electronic device. The increased interference increases an amount of shielding included within the electronic device to mitigate the interference. The increase in the number of antennas, the adjustment of the configuration of the antenna or the multiple antennas, or the combination thereof, reduces an area within the frame that is available for the other electronic components. The increase in the number of antennas, the adjustment of the configuration of the antenna or the multiple antennas, or the combination thereof, increases a complexity of the molding process for the frame of the electronic device.

This description describes an electronic device that includes an antenna section having a first surface and a second surface. The first surface is coupled to the second surface via a pivot and to a lid section of the electronic device. The second surface is coupled to the first surface via the pivot and to a base section of the electronic device. The base section is coupled to the lid section via a hinge section. In response to the base section and the lid section having a closed position, the antenna section is retracted within a cavity of the base section. In response to the base section and the lid section having an opened position, the antenna section extends from the cavity of the base section. The antenna section includes multiple antennas.

Locating antennas in the antenna section that is disposed within the cavity when the electronic device is in the closed position and extends outside the cavity when the electronic device is in the opened position increases an area within the frame that is available for other electronic components of the electronic device. The increased area for the other electronic components reduces an amount of shielding within the electronic device. The increased area for the other electronic components increases a screen to body ratio (STBR) of a display panel of the electronic device. Locating the antennas in the antenna section enhances antenna performance by reducing interference from the other electronic components. Locating the antennas in the antenna section enables a frame of the electronic device to be formed from a single material. Utilizing a single material for the frame of the electronic device reduces manufacture time and cost by eliminating the molding process for a composite frame.

In some examples in accordance with the present description, an electronic device is provided. The electronic device includes a lid section, a base section coupled to the lid section via a hinge section, the base section and the lid section having substantially parallel edges when in a closed position, and an antenna section including a first surface coupled to the lid section and a second surface coupled to the first surface via a pivot and to the base section. In response to a rotation of the hinge section, the pivot is to rotate between a first orientation when the base section and the lid section are in the closed position and a second orientation when the base section and the lid section are in an opened position.

In other examples in accordance with the present description, an electronic device is provided. The electronic device includes an antenna section including a first surface having a first edge coupled to a lid section of the electronic device and a second edge coupled to a pivot and a second surface having a third edge coupled to a wall of a cavity of a base section of the electronic device and a fourth edge coupled to the pivot, the second surface substantially perpendicular to the first surface when the lid section is in an opened position. The antenna section is to retract into the cavity of the base section when the lid section is in a closed position and to extend from the cavity when the lid section is in the opened position.

In yet other examples in accordance with the present description, an electronic device is provided. The electronic device includes a first section coupled to a second section via a hinge section, the first section including a cavity, and an antenna section including a first surface coupled to the cavity of the first section, the first surface including a first antenna, and a second surface coupled to the first surface via a pivot and to the second section, the second surface including a second antenna having a substantially perpendicular orientation to the first antenna. In response to the first section and the second section having an opened position, the first surface and the second surface extend outside of the cavity.

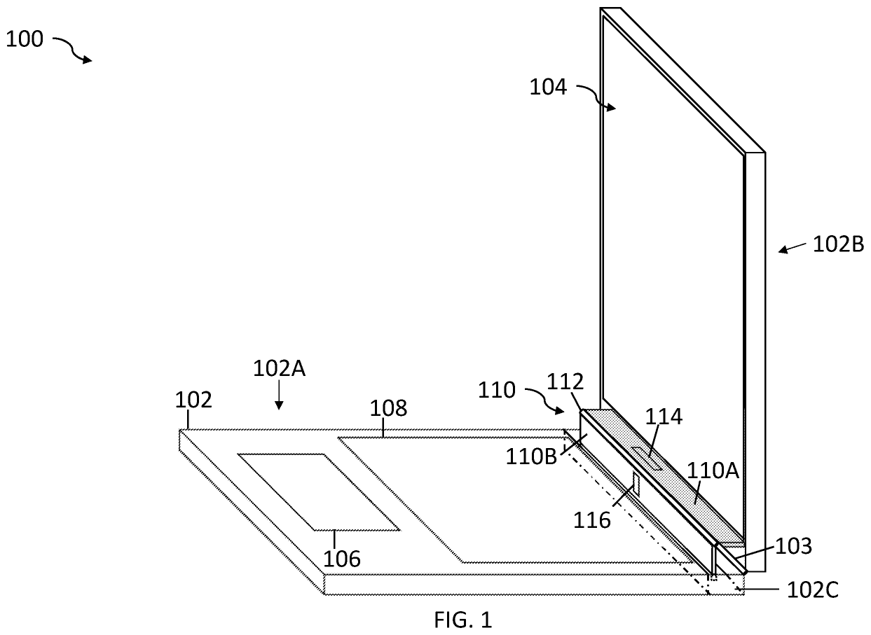

Referring now to FIG. 1, a block diagram of an electronic device 100 having an antenna section 110 is provided, in accordance with various examples. The electronic device 100 is a desktop, laptop, notebook, tablet, smartphone, or other suitable computing device that utilizes wireless communications, for example. The electronic device 100 includes a frame 102. The frame 102 is a metal, plastic, other suitable material for housing components of the electronic device 100, or a combination thereof. The frame 102 includes a base section 102A, a lid section 102B, a cavity 102C, and a hinge section 103.

In some examples, the base section 102A includes the cavity 102C and I/O devices 106, 108. The cavity 102C is formed during manufacture of the electronic device 100 as a portion of the base section 102A, for example. An I/O device 106 is a touchpad, for example. An I/O device 108 is a keyboard, for example. The lid section 102B includes a display panel 104. The display panel 104 is a liquid crystal display (LCD) panel, a light-emitting diode (LED) panel, a quantum dot (QD) panel, or any suitable panel for displaying data, for example. The cavity 102C includes the antenna section 110. The antenna section 110 includes surfaces 110A, 110B and a pivot 112. A material of the surfaces 110A, 110B is plastic or other suitable material that enables propagation of EM waves. A surface 110A includes an antenna 114. A surface 110B includes an antenna 116. The antennas 114, 116 are any suitable resonating material that transceives EM waves. The antenna 114, 116 is a slot antenna, a loop antenna, a planar inverted-F antenna (PIFA), or other suitable structure for transceiving EM waves, for example.

While not explicitly shown, in some examples, the electronic device 100 includes network interfaces, video adapters, sound cards, local buses, other I/O devices (e.g., a mouse, a speaker, a microphone), or a combination thereof. A connector (not explicitly shown) couples the antenna 114, 116 to other components of the electronic device 100. The connector is any suitable conductor for transmitting an EM wave. The connector is a coaxial cable, a micro-strip transmission line, or other structure for propagating the EM wave to or from a control circuitry (not explicitly shown), for example.

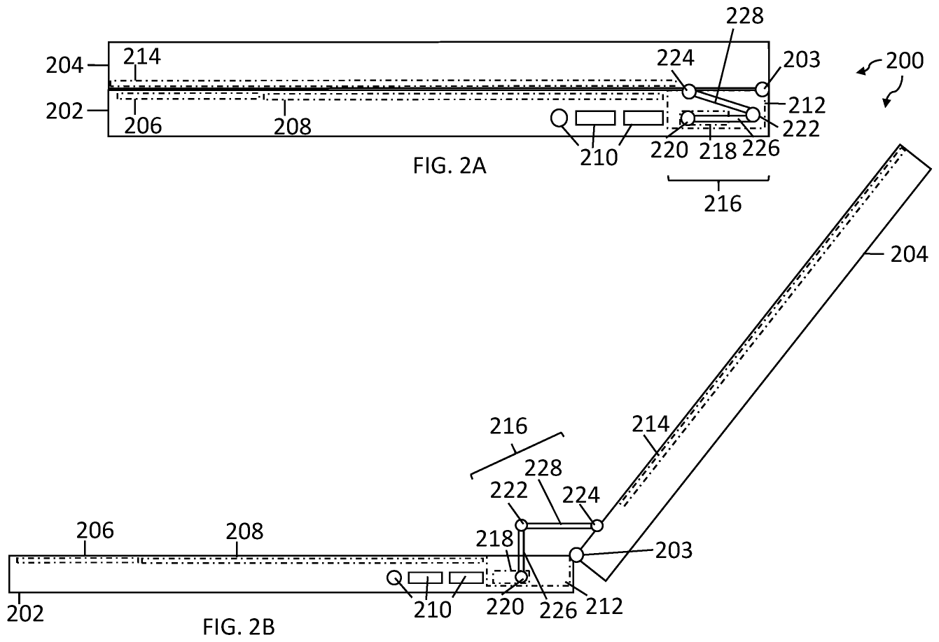

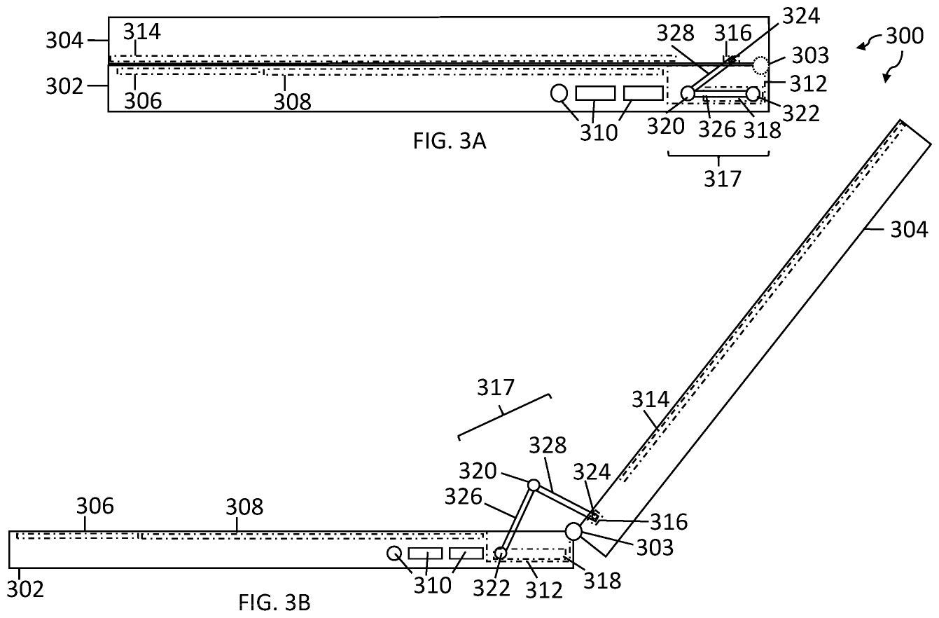

In various examples, the base section 102A is coupled to the lid section 102B via the hinge section 103. The base section 102A is coupled to the hinge section 103, and the hinge section 103 is coupled to the lid section 102B, for example. In some examples, the cavity 102C is formed within the base section 102A such that an exterior wall of the cavity 102C has a specified dimension to accommodate the hinge section 103. In various examples, the surface 110A is coupled to the surface 110B via the pivot 112 and the lid section 102B. The surface 110B is coupled to the surface 110A via the pivot 112 and the base section 102A. Refer to FIGS. 2A, 2B, 3A, and 3B below for examples describing different coupling configurations of the antenna section 110, the base section 102A, and the lid section 102B.

In some examples, the antennas 114, 116 resonate for various frequency bands. The various frequency bands include a 2.4 gigahertz (GHz) band, a 5 GHz band, a 1575 megahertz (MHz) band, or any other frequency band that enables wireless communications. In various examples, a standard or specification describes the frequency bands that enable wireless communications. The standard or specification is for a third generation (3G) wireless communication network, a fourth generation (4G) communication network, a fifth generation (5G) communication network, or other wireless communication network, for example. In various examples, the antennas 114, 116 are single-band antennas, multiband antennas, or a combination thereof.

While not explicitly shown, in various examples, the antennas 114, 116 include a substrate, a resonator plane, and a ground plane. The resonator plane and the ground plane are metal planes. Portions of a metal plane may be removed to form the resonator plane, for example. The metal plane is copper, gold, or other suitable metal. The substrate is any suitable di-electric material upon which the resonator plane and the ground plane are placed. The antennas 114, 116 are substrate integrated waveguide antennas, for example. In other examples, the antennas 114, 116 are formed by metal traces. The metal traces are printed foil structures, wires, or a combination thereof. Material of the metal traces are copper, gold, or other suitable metals. In some examples, the ground plane of the antennas 114, 116 couple to an electrical ground of the electronic device 100. The ground plane of the antennas 114, 116 are disposed on inward facing sides (e.g., facing toward the cavity 102C when in the opened position) of the surfaces 110A, 110B, for example. In other examples, the antennas 114, 116 couple to a control circuitry (not explicitly shown) that includes a tuning circuit to enable the antennas 114, 116 to operate within specified frequency bands. The tuning circuit includes a tunable capacitor, a matching circuit (e.g., an inductor and capacitor), a radio-frequency (RF) switch, an RF filter, or other circuitry that facilitates reception or transmission of the EM wave, for example.

In various examples, the hinge section 103 is secured to the base section 102A via mechanical fasteners (not explicitly shown). The lid section 102B is rotatable about an axis of rotation (not explicitly shown) of the hinge section 103 to adjust a position of the lid section 102B relative to the base section 102A. A closed position, as used herein, refers to an orientation in which the lid section 102B overlays the base section 102A. For example, in the closed position, the display panel 104 of the lid section 102B faces the I/O devices 106, 108 of the base section 102A. An opened position, as used herein, refers to an orientation in which the display panel 104 of the lid section 102B is viewable. For example, in the opened position, the lid section 102B is substantially perpendicular to the base section 102A.

In some examples, the orientation in which the electronic device 100 is in the closed position is referred to as a first orientation, and the orientation in which the electronic device 100 is in the opened position is referred to as a second orientation. In the first orientation, the antenna section 110 is disposed substantially within the cavity 102C of the base section 102A, and in the second orientation, the antenna section 110 is disposed substantially outside the cavity 102C of the base section 102A.

In some examples, the pivot 112 is secured to the surfaces 110A, 110B via mechanical fasteners (not explicitly shown). The surface 110A is secured to the cavity 102C via mechanical fasteners, as described below with respect to FIGS. 2-3, for example. In other examples, the cavity 102C includes a separate component of metal, plastic, or other suitable material for housing the antenna section 110. The separate component is secured to the cavity 102C via mechanical fasteners (not explicitly shown). Utilizing the separate component enables adjustment to a configuration of the antenna section 110 independent of the manufacture of the electronic device 100.

In various examples, in response to a rotation of the hinge section 103, the pivot 112 is to rotate the surfaces 110A, 110B between the first orientation and the second orientation. For example, in the closed position, the surfaces 110A, 110B have substantially parallel edges. Substantially parallel, as used herein, indicates that an angle between the two components is less than forty-five degrees. In response to the hinge section 103 rotating as the lid section 102B adjusts from the closed position to the opened position, the pivot 112 rotates so that the surfaces 110A, 110B adjust from having substantially parallel edges to having substantially perpendicular edges. Substantially perpendicular, as used herein, indicates that an angle between two components is between forty-five degrees and one hundred and thirty-five degrees.

In some examples, independent of the orientation, the surface 110A and the base section 102A have substantially parallel edges, and the surface 110B and the lid section 102B have substantially parallel edges. For example, in the first orientation and the second orientation, the surface 110A and the base section 102A have substantially parallel edges, and the surface 110B and the lid section 102B have substantially parallel edges. In other examples, independent of the orientation of the surfaces 110A, 110B, the antenna 114 is in a substantially perpendicular orientation to the antenna 116.

In some examples, the electronic device 100 includes a first section, the base section 102A, coupled to a second section, the lid section 102B, via the hinge section 103. The first section includes the cavity 102C. The antenna section 110 includes a first surface, the surface 110B, coupled to the cavity 102C of the first section. The first surface includes a first antenna, the antenna 114. The antenna section 110 includes a second surface, the surface 110A, coupled to the first surface via the pivot 112 and to the second section. The second surface includes a second antenna, the antenna 116, having a substantially perpendicular orientation to the first antenna. In response to the first section and the second section having an opened position, the second surface is substantially perpendicular to the second section and the first surface is substantially perpendicular to the second surface. In various examples, in response to the first section and the second section having a closed position, edges of the first surface, the second surface, the first section, and the second section are substantially parallel.

Locating the antennas 114, 116 in the antenna section 110 that is disposed within the cavity 102C when the electronic device 100 is in a closed position and extends outside the cavity 102C when the electronic device 100 is in the opened position increases an area within the frame 102 that is available for other electronic components of the electronic device 100. The increased area for the other electronic components reduces an amount of shielding within the electronic device 100. In some examples, the increased area increases a screen to body ratio (STBR) of the display panel 104. Locating the antennas 114, 116 in the antenna section 110 enhances antenna performance by reducing interference from the other electronic components. Disposing ground planes of the antennas 114, 116 on inward facing sides of the surfaces 110A, 110B reduces interference to the other electronic components from the antennas 114, 116. The antenna section 110 that extends from the cavity 102C enables the frame 102 to be made of a single material since portions of the frame 102 do not need to accommodate transceiving of EM waves by antennas located within the frame 102.

Referring now to FIGS. 2A and 2B, block diagrams of an electronic device 200 having an antenna section 216 are provided, in accordance with various examples. In some examples, the electronic device 200 may be similar to the electronic device 100. For example, the electronic device 200 may include some or all of the components of the electronic device 100 having different implementations as described below. The antenna section 216 is the antenna section 110, for example. The electronic device 200 includes a base section 202, a hinge section 203, and a lid section 204. The base section 202 is the base section 102A, for example. The hinge section 203 is the hinge section 103, for example. The lid section 204 is the lid section 102B, for example. The base section 202 includes I/O devices 206, 208, ports 210, and a cavity 212. The I/O devices 206, 208 are the I/O devices 106, 108, for example. The ports 210 are connectors that enable additional I/O devices to couple to the electronic device 200. The ports 210 include a universal serial bus (USB) connector, an audio device connector, a display device connector, or a combination thereof, for example. The cavity 212 is the cavity 102C, for example. The lid section 204 includes a display panel 214. The display panel 214 is the display panel 104, for example.

In various examples, the cavity 212 includes the antenna section 216, and a slot 218. The slot 218 is for receiving a slidable member. The slot 218 is formed as a portion of the cavity 212, for example. In another example, the slot 218 is an independent component coupled to a wall of the cavity 212 via mechanical fasteners (not explicitly shown). The antenna section 216 includes pivots 220, 222, 224 and surfaces 226, 228. The pivots 220, 222, 224 are any suitable device that enables rotation about an axis. The pivots 220, 222, 224 are hinges, for example. A surface 226 is the surface 110B, for example. A surface 228 is the surface 110A, for example.

In some examples, the base section 202, the hinge section 203, the lid section 204, the cavity 212, the antenna section 216, the surfaces 226, 228, and a pivot 222 couple to each other as described above with respect to FIG. 1. In other examples, a pivot 220 is a component that facilitates sliding within a slot or groove. The pivot 220 is a wheel, for example. The pivot 220 is disposed within the slot 218. A pivot 224 couples to the lid section 204.

In various examples, the electronic device 200 of FIG. 2A is referred to as having a closed position, and the electronic device 200 of FIG. 2B is referred to as having an opened position. The electronic device 200 includes the antenna section 216 including a first surface, the surface 228, having a first edge coupled to the lid section 204 of the electronic device 200 and a second edge coupled to the pivot 222 and a second surface, the surface 226, having a third edge coupled to a wall of the cavity 212 of the base section 202 of the electronic device 200 and a fourth edge coupled to the pivot 222. The antenna section 216 is to retract into the cavity 212 of the base section 202 when the lid section 204 is in the closed position and to extend from the cavity 212 when the lid section 204 is in the opened position, for example. As shown in FIG. 2B, the second surface is substantially perpendicular to the first surface when the lid section 204 is in the opened position.

As described above with respect to FIG. 1, in some examples, in response to a rotation of the hinge section 203, the pivots 220, 222, 224 are to rotate the surfaces 226, 228 between a first orientation and a second orientation. For example, in the closed position, the surfaces 226, 228 have substantially parallel edges. In response to the hinge section 203 rotating as the lid section 204 adjusts from the closed position to the opened position, the pivots 220, 222, 224 rotate so that the surfaces 226, 228 adjust from having substantially parallel edges, as shown in FIG. 2A, to having substantially perpendicular edges, as shown in FIG. 2B. For example, the third edge couples to a first wall of the cavity 212 via the second pivot, the pivot 220, and a second wall (not explicitly shown) of the cavity 212 via a third pivot (not explicitly shown). The first wall is opposite to the second wall. In another example, the cavity 212 includes a first slot, the slot 218, on the first wall and a second slot (not explicitly shown) on the second wall. The second pivot is a first end of a hinge disposed within the first slot and the third pivot is a second end of the hinge disposed within the second slot. In response to the antenna section 216 retracting or extending from the cavity 212, the first end of the hinge and the second end of the hinge slide within the first slot and the second slot, respectively. The first end of the hinge and the second end of the hinge sliding with the first slot and the second slot, respectively, enable the antenna section 216 to rotate about an axis of the pivot 222 between the first orientation and the second orientation. For example, in response to the hinge section 203 rotating to open the lid section 204, the first end of the hinge and the second end of the hinge slide toward a side of the cavity 212 nearest the hinge section 203 (e.g., a backside of the electronic device 200). In response to the hinge section 203 rotating to close the lid section 204, the first end of the hinge and the second end of the hinge slide toward the side of the cavity 212 away from the hinge section 203. In the closed position, the pivot 222 is disposed within the cavity 212 on the side of the cavity 212 nearest the hinge section 203 and the antenna section 216 is fully retracted into the cavity 212.

In various examples, in response to the antenna section 216 retracting or extending from the cavity 212, lengths of the first slot and the second slot of the cavity 212 prevent the surface 226 from rotating such that an angle between the surface 226 and the base section 202 is beyond a specified degree. For example, the lengths of the first slot and the second slot of the cavity 212 prevent the surface 226 from rotating beyond a 120 degree angle with the base section 202. In some examples, in response to the hinge section 203 rotating to open the lid section 204, the pivot 220 remains at a first end of the slot 218 and the pivots 222, 224 rotate to enable the surface 228 to extend from the cavity 212. When an angle between the surface 228 and the lid section 204 exceeds a second specified degree, the pivot 220 slides within the slot 218 toward a second end of the slot 218 that is nearest the hinge section 203. In response to the hinge section 203 rotating to close the lid section 204, the pivot 220 slides within the slot 218 toward the first end of the slot 218 that is away from the hinge section 203. When the pivot 220 contacts the first end of the slot, the pivots 222, 224 rotate to enable the surface 228 to retract into the cavity 212.

While not explicitly shown, the surfaces 226, 228 include an antenna, multiple antennas, or a combination thereof. In various examples, the antennas are disposed on the surfaces 226, 228 such that resonating elements of antennas are on a side of the surfaces 226, 228, respectively, that face outward from the electronic device 200 when in the opened position. In some examples, when in the closed position, the side of the surface 228 that faces outward from the electronic device 200 when in the opened position faces the side of the surface 226 that faces outward from the electronic device 200 when in the opened position. For example, the pivot 222 is able to rotate approximately two-hundred and seventy degrees as the pivot 220 slides in the slot 218.

Referring now to FIGS. 3A and 3B, block diagrams of an electronic device 300 having an antenna section 317 are provided, in accordance with various examples. In some examples, the electronic device 300 may be similar to the electronic device 100, 200. For example, the electronic device 300 may include some or all of the components of the electronic device 100, 200 having different implementations as described below. The antenna section 317 is the antenna section 110, 216, for example. The electronic device 300 includes a base section 302, a hinge section 303, and a lid section 304. The base section 302 is the base section 102A, 202, for example. The hinge section 303 is the hinge section 103, 203, for example. The lid section 304 is the lid section 102B, 204, for example. The base section 302 includes I/O devices 306, 308, ports 310, a cavity 312. The I/O devices 306, 308 are the I/O devices 106, 108 or the I/O devices 206, 208, for example. The ports 310 are the ports 210, for example. The cavity 312 is the cavity 102C, 212, for example. The lid section 304 includes a display panel 314 and a cavity 316. The display panel 314 is the display panel 104, 214, for example. The cavity 316 is a slot or groove for receiving a hinge.

In various examples, the cavity 312 includes the antenna section 317, and a slot 318. Similar to the slot 218, the slot 318 is for receiving a slidable member. The antenna section 317 includes pivots 320, 322, 324 and surfaces 326, 328. The pivots 320, 322, 324 are any suitable device that enables rotation about an axis. The pivots 320, 322, 324 are hinges, for example. A surface 326 is the surface 110B, 226, for example. A surface 328 is the surface 110A, 228, for example.

In some examples, the base section 302, the hinge section 303, the lid section 304, the cavity 312, the antenna section 317, the surfaces 326, 328, and a pivot 320 couple to each other as described above with respect to FIG. 1 or 2. In other examples, a pivot 322 is a component that facilitates sliding within a slot or groove. The pivot 322 is a wheel, for example. The pivot 322 is disposed within the slot 318. A pivot 324 facilitates rotation within the cavity 316, for example.

In various examples, the electronic device 300 of FIG. 3A is referred to as having a closed position, and the electronic device 300 of FIG. 3B is referred to as having an opened position. The electronic device 300 includes the lid section 304, the base section 302 coupled to the lid section 304 via the hinge section 303. The base section 302 and the lid section 304 have substantially parallel edges when in the closed position. The antenna section 317 includes a first surface, the surface 328, coupled to the lid section 304 and a second surface, the surface 326, coupled to the first surface via a first pivot, the pivot 320, and to the base section 302. In response to a rotation of the hinge section 303, the first pivot rotates the first and the second surfaces between a first orientation (e.g., the base section 302 and the lid section 304 are in the closed position) and a second orientation (e.g., the base section 302 and the lid section 304 are in the opened position). In some examples, the second surface is coupled to the lid section 304 via a second pivot, the pivot 324. In response to the rotation of the hinge section 303, the second pivot is to rotate between the first orientation in which the second surface is substantially parallel to the first surface and the second orientation in which the second surface is substantially perpendicular to the first surface. In various examples, the second pivot is coupled to a second cavity, the cavity 316, of the lid section 304.

In some examples, a first edge of the surface 326 couples to a first wall of the cavity 312 via a first pivot, the pivot 322, and a second wall (not explicitly shown) of the cavity 312 via a second pivot (not explicitly shown). The first wall is opposite to the second wall. In various examples, the cavity 312 includes a first slot, the slot 318, on the first wall and a second slot (not explicitly shown) on the second wall. The first pivot is a first end of a hinge disposed within the first slot and the second pivot is a second end of the hinge disposed within the second slot, for example. In response to the antenna section 317 retracting or extending from the cavity 312, the first end of the hinge and the second end of the hinge slide within the first slot and the second slot, respectively. For example, in response to the hinge section 303 rotating to open the lid section 304, the first end of the hinge and the second end of the hinge slide away from a side of the cavity 312 nearest the hinge section 303 (e.g., a backside of the electronic device 300). In response to the hinge section 303 rotating to close the lid section 304, the first end of the hinge and the second end of the hinge slide toward the side of the cavity 312 nearest the hinge section 303. In the closed position, the pivot 320 is disposed within the cavity 312 opposite to the side of the cavity 312 nearest the hinge section 303.

In various examples, a first edge of the surface 328 couples to a first wall of the cavity 316 via a first pivot, the pivot 324, and a second wall (not explicitly shown) of the cavity 316 via a second pivot (not explicitly shown). The first wall is opposite to the second wall. The first pivot is a first end of a hinge disposed within the first slot and the second pivot is a second end of the hinge disposed within the second slot, for example. In response to the antenna section 317 retracting or extending from the cavity 312, the first end of the hinge and the second end of the hinge rotate within the cavity 316, respectively. In response to the hinge section 303 rotating to open the lid section 304, a first side of the cavity 316 nearest the hinge section 303 prevents the surface 328 from rotating beyond a specified degree. In response to the surface 328 contacting the first side of the cavity 316, the pivot 322 slides within the first slot of the cavity 312 away from the hinge section 303. In response to the hinge section 303 rotating to close the lid section 304, a second side a side of the cavity 316 that is opposite to the first side prevents the surface 328 from rotating beyond a second specified degree. In response to the surface 328 contacting the second side of the cavity 316, the pivot 322 slides within the first slot of the cavity 312 toward from the hinge section 303 such that the antenna section 317 fully retracts into the cavity 312 before the lid section 304 is fully closed.

While not explicitly shown, the surfaces 326, 328 include an antenna, multiple antennas, or a combination thereof. In various examples, the antennas are disposed on the surfaces 326, 328 such that resonating elements of the antennas are on a side of the surfaces 326, 328, respectively, that face outward from the electronic device 300 when in the opened position. In some examples, when in the closed position, the side of the surface 326 that faces outward from the electronic device 300 when in the opened position faces a bottom side of the cavity 312. In other examples, when in the closed positions, a ground plane side of the antennas on the surface 328 are disposed on the ground plane side of the antennas on the surface 326.

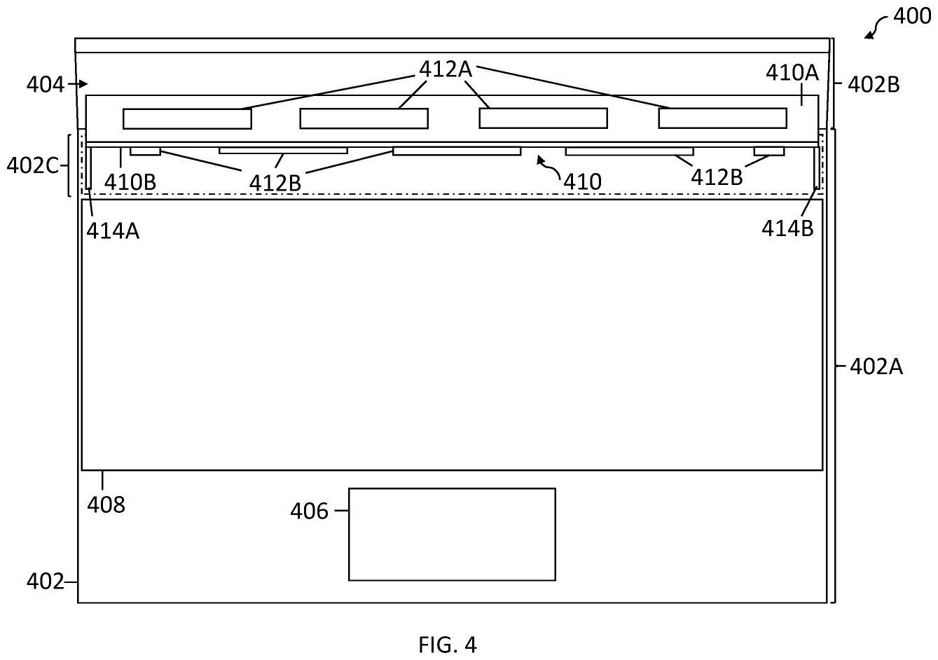

Referring now to FIG. 4, a block diagram of a top-down view of an electronic device 400 having an antenna section 410 is provided, in accordance with various examples. In some examples, the electronic device 400 is implemented as the electronic device 100, 200, 300. The antenna section 410 is the antenna section 110, 216, 317, for example. The electronic device 400 includes a frame 402. The frame 402 is the frame 102, for example. The frame 402 includes a base section 402A and a lid section 402B. The base section 402A is the base section 102A, 202, 302, for example. The lid section 402B is the lid section 102B, 204, 304, for example. The base section 402A includes a cavity 402C and 1/O devices 406, 408. The cavity 402C is the cavity 102C, 212, 312, for example. The I/O devices 406, 408 are the I/O devices 106, 108, the I/O devices 206, 208, or the I/O devices 306, 308, for example. The lid section 402B includes a display panel 404. The display panel 404 is the display panel 104, 214, 314, for example.

In various examples, the cavity 402C includes the antenna section 410 and the slots 414A, 414B. The antenna section 410 includes surfaces 410A, 410B. The surfaces 410A, 410B are the surfaces 110A, 110B, respectively; the surfaces 228, 226, respectively; or the surfaces 328, 326, respectively. A slot 414B is the slot 218, 318, for example. The surface 410A includes multiple antennas 412A. The multiple antennas 412A include the antenna 114, for example. The surface 410B includes multiple antennas 412B. The multiple antennas 412B include the antenna 116, for example.

In some examples, the multiple antennas 412A of surface 410A and the multiple antennas 412B of surface 410B are disposed on the surfaces 410A, 410B to facilitate reduction of a specific absorption rate (SAR) of EM waves radiating from the electronic device 400. For example, the multiple antennas 412A operate within a 2.4 GHz band while the multiple antennas 412B operate within a 5 GHz band. In some examples, the multiple antennas 412B operate within the 4G, 5G, and sub-6G specifications. The multiple antennas 412A operate within the Wi-Fi specification. In other examples, two antennas of the multiple antennas 412B are substantially perpendicular to a third antenna of the multiple antennas 412B. The perpendicular orientation of the three antennas enable two-hundred and seventy degree radiation coverage within a millimeter (mm) wave band.

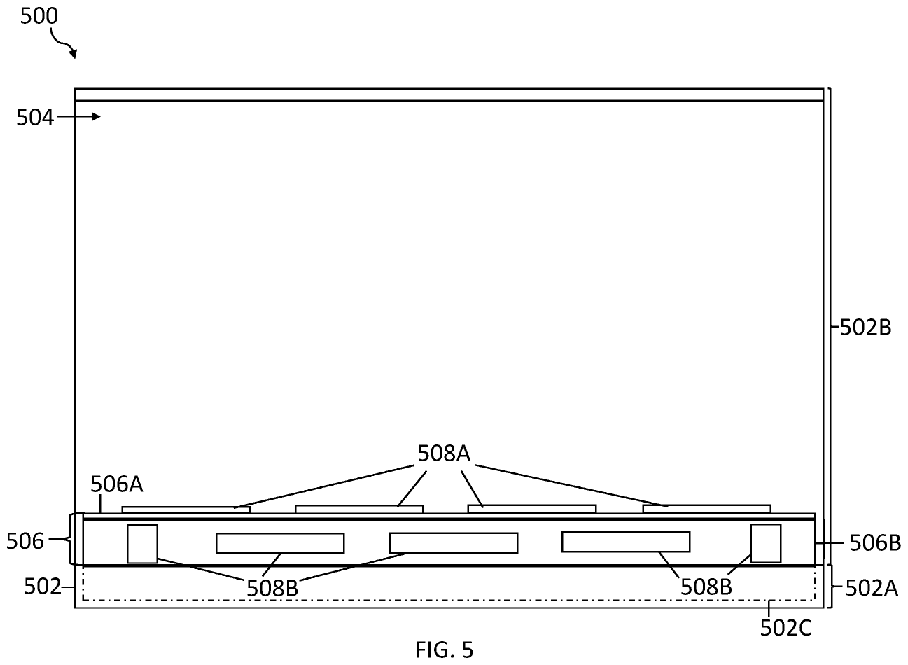

Referring now to FIG. 5, a block diagram of a front-facing view of an electronic device 500 having an antenna section 506 is provided, in accordance with various examples. In some examples, the electronic device 500 is implemented as the electronic device 100, 200, 300, 400. The antenna section 506 is the antenna section 110, 216, 317, 410, for example. The electronic device 500 includes a frame 502. The frame 502 is the frame 102, 402, for example. The frame 502 includes a base section 502A and a lid section 502B. The base section 502A is the base section 102A, 202, 302, 402A, for example. The lid section 502B is the lid section 102B, 204, 304, 402B, for example. The base section 502A includes a cavity 502C. The cavity 502C is the cavity 102C, 212, 312, 402C, for example. The lid section 502B includes a display panel 504. The display panel 504 is the display panel 104, 214, 314, 404, for example.

In various examples, the cavity 502C includes the antenna section 506. The antenna section 506 includes surfaces 506A, 506B. The surfaces 506A, 506B are the surfaces 110A, 110B, respectively; the surfaces 228, 226, respectively; the surfaces 328, 326, respectively; or the surfaces 410A, 410B, respectively. The surface 506A includes multiple antennas 508A. The multiple antennas 508A include the antenna 114, for example. The surface 506B includes multiple antennas 508B. The multiple antennas 508B include the antenna 116, for example.

As described above with respect to FIG. 4, in some examples, two antennas of the multiple antennas 508B are substantially perpendicular to a third antenna of the multiple antennas 508B. The perpendicular orientation of the three antennas enable two-hundred and seventy degree radiation coverage within a millimeter (mm) wave band.

In some examples, the surface 506B couples to an exterior wall of the cavity 502C. The surface 506B couples to the exterior wall via a hinge that rotates within a slot of the exterior wall. In various examples, the surface 506B couples to the exterior wall via a first hinge disposed on a first end of an edge of the surface 506B and via a second hinge disposed on a second end of the edge of the surface 506B. The first hinge is disposed within a first end of the slot and the second hinge is disposed within a second end of the slot, for example. In another example, the first hinge is disposed within a first slot of the exterior wall and the second hinge is disposed within a second slot of the exterior wall.

In other examples, the surface 506A couples to a portion of the lid section 502B that is disposed below the display panel 504. The surface 506A couples to the portion of the lid section 502B via a hinge that rotates within a slot of the portion. In various examples, the surface 506A couples to the portion via a first hinge disposed on a first end of an edge of the surface 506A and via a second hinge disposed on a second end of the edge of the surface 506A. The first hinge is disposed within a first end of the slot and the second hinge is disposed within a second end of the slot, for example. In another example, the first hinge is disposed within a first slot of the portion and the second hinge is disposed within a second slot of the portion.

While shown as rectangular planes in the above examples, in other examples, the surfaces 110A, 110B; 226, 228; 326, 328; 410A, 410B; 506A, 506B of the antenna section 110, 216, 317, 410, 506, respectively, are any suitable shape for housing antennas, facilitating propagation of EM waves, or a combination thereof. While shown as a cuboidal structure in the examples above, in other examples, the cavity 102C, 212, 312, 402C. 502C is any suitable shape for housing the antenna section 110, 216, 317, 410, 506. While shown as spanning a substantial length of the base section 102A, 202, 302, 402A, 502A, in some examples, the cavity 102C, 212, 312, 402C, 502C has a length that is a portion of the length of the base section 102A, 202, 302, 402A, 502A. In other examples, the electronic device 100, 200, 300, 400, 500 includes multiple cavities, where the multiple cavities span the substantial length of the base section 102A, 202, 302, 402A, 502A.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . .” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
a lid section;
a base section coupled to the lid section via a hinge section, the base section and the lid section having substantially parallel edges when in a closed position; and
an antenna section including:
a first surface coupled to the lid section; and
a second surface coupled to the first surface via a pivot and to the base section,
wherein, in response to a rotation of the hinge section, the pivot is to rotate the antenna section between a first orientation when the base section and the lid section are in the closed position and a second orientation when the base section and the lid section are in an opened position.

2. The electronic device of claim 1, wherein the antenna section is disposed substantially within a cavity of the base section in the first orientation, and wherein the antenna section is disposed substantially outside the cavity of the base section in the second orientation.

3. The electronic device of claim 1, wherein the antenna section includes multiple antennas.

4. The electronic device of claim 1, wherein the first surface includes a first antenna and the second surface includes a second antenna, the first antenna having a substantially perpendicular orientation to the second antenna.

5. The electronic device of claim 1, wherein, in the first orientation and in the second orientation, the first surface and the base section are to have substantially parallel edges and the second surface and the lid section are to have substantially parallel edges.

6. An electronic device, comprising:
an antenna section including:
a first surface having a first edge coupled to a lid section of the electronic device and a second edge coupled to a pivot; and
a second surface having a third edge coupled to a wall of a cavity of a base section of the electronic device and a fourth edge coupled to the pivot, the second surface substantially perpendicular to the first surface when the lid section is in an opened position,
wherein the antenna section is to retract into the cavity of the base section when the lid section is in a closed position and to extend from the cavity when the lid section is in the opened position.

7. The electronic device of claim 6, wherein the third edge is to couple to a first wall of the cavity via a second pivot and a second wall of the cavity via a third pivot, the first wall opposite to the second wall.

8. The electronic device of claim 7, wherein the cavity includes a first slot on the first wall and a second slot on the second wall, wherein the second pivot is a first end of a hinge disposed within the first slot and the third pivot is a second end of the hinge disposed within the second slot, and wherein, in response to the antenna section retracting or extending from the cavity, the first end of the hinge and the second end of the hinge are to slide within the first slot and the second slot, respectively.

9. The electronic device of claim 6, wherein the antenna section includes multiple antennas, wherein a first antenna of the multiple antennas is disposed on the first surface and a second antenna of the multiple antennas is disposed on the second surface, and wherein the first antenna is to have a substantially perpendicular orientation to the second antenna.

10. The electronic device of claim 6, wherein, in response to the lid section adjusting from the closed position to the opened position, the pivot is to rotate the antenna section between being retracted into the cavity and extended from the cavity, respectively.

11. An electronic device, comprising:
a first section coupled to a second section via a hinge section, the first section including a cavity; and
an antenna section including:
a first surface coupled to the cavity of the first section, the first surface including a first antenna; and
a second surface coupled to the first surface via a pivot and to the second section, the second surface including a second antenna having a substantially perpendicular orientation to the first antenna,
wherein, in response to the first section and the second section having an opened position, the first surface and the second surface extend outside of the cavity.

12. The electronic device of claim 11, wherein, in response to the first section and the second section having a closed position, edges of the first surface, the second surface, the first section, and the second section are substantially parallel.

13. The electronic device of claim 11, wherein a first edge of the first surface is coupled to a first wall of the cavity and a second edge of the first surface is coupled to a second wall of the cavity, and wherein the first edge is opposite to the second edge and the first wall is opposite to the second wall.

14. The electronic device of claim 11, wherein the second surface is coupled to the second section via a second pivot, and wherein, in response to a rotation of the hinge section, the second pivot is to rotate between a first orientation in which the second surface is substantially parallel to the first surface and a second orientation in which the second surface is substantially perpendicular to the first surface.

15. The electronic device of claim 14, wherein the second pivot is coupled to a second cavity of the second section.
